(19) United States
(12) Patent Application Publication
(10) Pub. No.: US 2025/0229360 A1
(43) Pub. Date: Jul. 17, 2025

(54) SYSTEM FOR INSPECTING AND REVISING WELDS

(71) Applicant: GM GLOBAL TECHNOLOGY OPERATIONS LLC, Detroit, MI (US)

(72) Inventors: Guangze Li, Novi, MI (US); Daniel Benedito Nishihara JORGE, Troy, MI (US); Fahad Malmood BASAR, Clarkston, MI (US); Hui-ping WANG, Troy, MI (US); Blair E. CARLSON, Ann Arbor, MI (US)

(21) Appl. No.: 18/413,262

(22) Filed: Jan. 16, 2024

(51) Int. Cl. B23K 26/08; B23K 26/03

(52) U.S. Cl. CPC B23K 26/0884; B23K 26/032

(57) ABSTRACT

A system for inspecting and revising welds. The system includes: a weld inspection sensor configured to inspect weld parameters of the welds; an inspection controller configured to identify one or more of the welds as an imperfect weld based on the weld parameters; a system controller configured to designate the imperfect weld for revision based on the weld parameters of, and relative locations of, the welds that are proximate to the imperfect weld designated for revision; a welding robot controller configured to operate a welding robot to perform a revision weld at the imperfect weld; and a weld verification sensor configured identify a revision location of the revision weld. The system controller is configured to verify the revision weld based on the revision location identified by the weld verification sensor.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to a system for inspecting and revising welds, such as laser welds.

Welding is a fabrication process that joins materials, such as metals or thermoplastics. Welding uses high heat to melt the materials together. As the materials cool, they fuse together. The strength of the weld depends on a number of factors, including the weld geometry, phase, microstructures, and structure inside the welds. Welds are grouped by distance to ensure adequate load bearing capability within each group. Limited number of imperfect welds is acceptable within each group as ensured by the weld design.

### SUMMARY

The present disclosure includes, in various features, a system for inspecting and revising welds. The system includes: a weld inspection sensor configured to inspect weld parameters of the welds; an inspection controller configured to identify a group of the welds, and identify one or more of the welds of the group as an imperfect weld based on the weld parameters; a system controller configured to designate the imperfect weld for revision based on the weld parameters of the welds of the group and quantity of the welds of the group identified as imperfect by the inspection controller; a welding robot controller configured to operate a welding robot to perform a revision weld at the imperfect weld; and a weld verification sensor configured identify a revision location of the revision weld. The system controller is configured to verify the revision weld based on the revision location identified by the weld verification sensor.

In further features, the welds are on a battery support tray or floor pan of an electric vehicle.

In further features, the weld inspection sensor includes at least one three-dimensional camera.

In further features, the weld verification sensor includes at least one two-dimensional camera.

In further features, the weld parameters include weld location and at least one of weld surface concavity and weld length.

In further features, the system controller is configured to designate the imperfect weld for revision when the quantity of the welds of the group identified as imperfect exceeds a predetermined limit.

In further features, the system controller is configured to designate the imperfect weld as acceptable when the imperfect weld the quantity of the welds of the group identified as imperfect is below a predetermined limit.

In further features, the system controller is configured to, based on the weld parameters of the imperfect weld, formulate revision weld instructions for the revision weld and transmit the revision weld instructions to the welding robot controller, and the welding robot controller is configured to operate the welding robot to perform the revision weld at the imperfect weld based on the revision weld instructions.

In further features, the revision weld includes at least one of a metal inert gas weld and a laser weld.

In further features, a verification controller is configured to receive the revision location of the revision weld, operate the weld verification sensor to check the revision location for the revision weld, and notify the system controller of the presence of, or absence of, the revision weld at the revision location.

In further features, the inspection controller is configured to identify one or more of the welds as imperfect by comparing the weld parameters to predetermined parameters.

The present disclosure further includes, in various features, a system for inspecting and revising welds. The system includes: a weld inspection sensor configured to inspect weld parameters of the welds including at least one of weld surface concavity, weld length, and weld continuity; an inspection controller configured to identify a group of the welds, and identify one or more of the welds of the group as an imperfect weld based on the weld parameters; a system controller configured to designate the imperfect weld for revision based on the weld parameters of the welds of the group and quantity of the welds of the group identified as imperfect by the inspection controller, wherein based on the weld parameters of the imperfect weld, the system controller is further configured to formulate revision weld instructions for a revision weld; a welding robot controller configured to receive the revision weld instructions from the system controller and operate a welding robot to perform the revision weld at the imperfect weld designated for revision based on the revision weld instructions; and a verification controller configured to operate a weld verification sensor configured to perform a verification to determine whether or not the revision weld is present at the imperfect weld designated for revision, and transmit results of the verification to the system controller, wherein the system controller is configured to verify the revision weld based on the results of the verification received from the system controller.

In further features, the weld inspection sensor includes at least one three-dimensional camera.

In further features, the weld verification sensor includes at least one two-dimensional camera.

In further features, the system controller is configured to designate the imperfect weld for revision when the quantity of the welds of the group identified as imperfect exceeds a predetermined limit, and the system controller is configured to designate the imperfect weld as acceptable when the quantity of the welds of the group identified as imperfect is at or below the predetermined limit.

The present disclosure also includes, in various features, a method for inspecting and revising welds. The method includes: inspecting weld parameters of the welds with a weld inspection sensor; identifying with an inspection controller a group of the welds, and one or more of the welds of the group as an imperfect weld based on the weld parameters; designating with a system controller the imperfect weld for revision based on the weld parameters of the welds of the group and quantity of the welds of the group identified as imperfect by the inspection controller, and relative locations of, the welds that are proximate to the imperfect weld; operating a welding robot with a welding robot controller to perform a revision weld at the imperfect weld designated for revision; identifying a revision location of the revision weld with a weld verification sensor; and verifying the revision weld with the system controller based on the revision location identified by the weld verification sensor.

In further features, the method includes identifying the revision location with multiple two-dimensional cameras.

In further features, the method includes designating with the system controller the imperfect weld for revision when the quantity of the welds of the group identified as imperfect exceeds a predetermined limit.

In further features, the method includes designating the imperfect weld as acceptable with the system controller when the quantity of the welds of the group identified as imperfect is below a predetermined limit.

In further features, the method includes formulating revision weld instructions for the revision weld with the system controller based on the weld parameters of the imperfect weld designated for revision, and transmitting the revision weld instructions to the welding robot controller.

### BRIEF DESCRIPTION OF THE DRAWINGS

The present disclosure will become more fully understood from the detailed description and the accompanying drawings, wherein:

FIG. 1 illustrates an exemplary system for revising welds in accordance with the present disclosure;

FIG. 2 is a perspective view of an exemplary automotive application for the system, an exemplary weld inspection sensor, and an exemplary weld verification sensor (in phantom); and

FIG. 3 illustrates area 3 of FIG. 2 in additional detail;

FIG. 4 illustrates additional features of the system for inspecting and revising welds; and

FIG. 5 illustrates a method in accordance with the present disclosure for inspecting and revising welds.

In the drawings, reference numbers may be reused to identify similar and/or identical elements.

### DETAILED DESCRIPTION

The present disclosure includes systems and methods for inspecting and revising welds. The systems and methods provide for automated inspection and revision controlled by a system controller. The system controller coordinates operations of a weld inspection system, a weld revision system, and a weld revision verification system. The present disclosure allows for a high number of welds to be inspected, revised, and verified automatically without meaningfully slowing manufacturing. With respect to verification, for example, only the existence of a revision weld is verified, rather than specific parameters of the revision weld, thereby maintaining production at high levels.

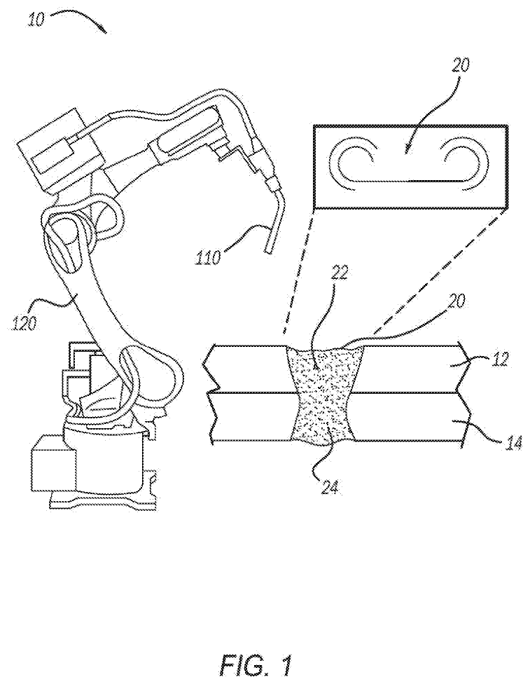

FIG. 1 illustrates a system 10 in accordance with the present disclosure for revising welds. The present disclosure applies to any suitable welds, such as a weld 20 for joining a first part 12 and a second part 14 together. The weld 20 generally includes a first welded area 22 of the first part 12 and a second welded area 24 of the second part 14. The first welded area 22 and the second welded area 24 have been heated above the melting points of the first part 12 and the second part 14, and then allowed to cool. Upon cooling, the first welded area 22 and the second welded area 24 become fused together to secure the first part 12 and the second part 14 together. In the example of FIG. 1, the weld 20 is formed with a weld structure generally known as a “staple” weld. The present disclosure applies to any other type of weld as well.

The weld 20 may be formed by any suitable welding process, such as, but not limited to, laser welding, electron beam welding, arc welding, etc. FIG. 1 illustrates an exemplary welding element 110 for forming and/or revising the weld 20. The welding element 110 may be maneuvered in any suitable manner, such as with a robotic arm 120. Alternatively, the welding element 110 may be held stationary, and the first part 12 and second part 14 may be moved opposite to the welding element 110. The welding element 110 may be controlled by any suitable controller. For example, the welding element 110 may be controlled by a welding robot controller 334 to revise the weld 20, as explained herein. The welding robot controller 334 is configured to maneuver the robotic arm 120 and/or any actuatable member on which the first and second parts 12, 14 are seated.

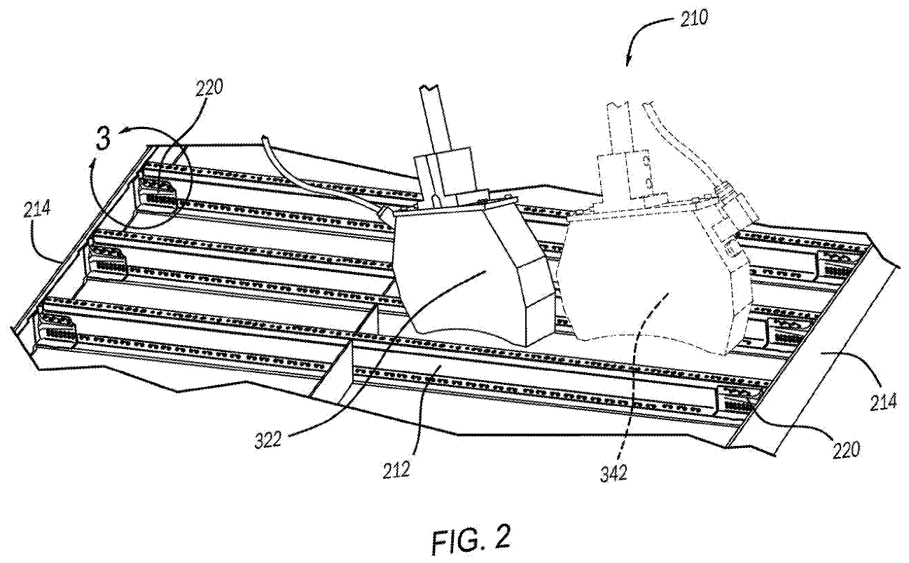

The first part 12 and the second part 14 may be made of the same material, or different materials. For example, each one of the first part 12 and the second part 14 may be made of any suitable metallic material, zinc coated steel, steel, aluminum, copper, Ni, Ti, high entropy alloys (HEAs), or a polymer. The first and second parts 12 and 14 may be any parts suitable to be welded together. For example and with reference to FIG. 2, the first part 12 and the second part 14 may be components of a battery support tray 210 for a vehicle. The first part 12 and the second part 14 may also be components of a vehicle body, such as a “body in white.” The weld 20 may be used to join parts for use in any other suitable application as well, such as, but not limited to, aerospace (e.g., joining fuselage components for wing components), ship building (e.g., joining components of a ship hull), medical applications, etc.

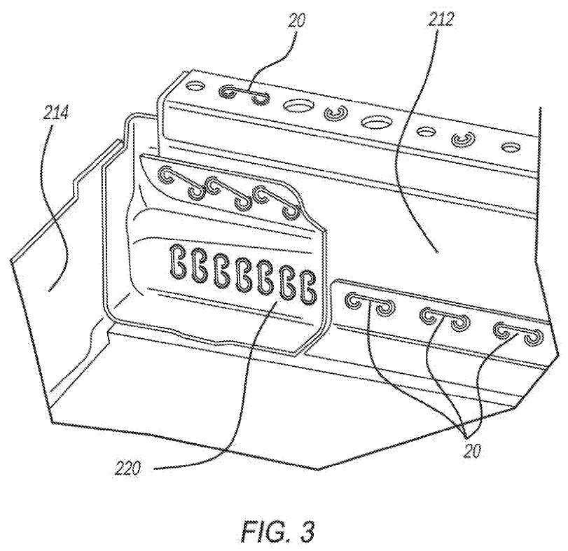

With respect to the exemplary battery support tray 210 of FIG. 2, the tray 210 includes a plurality of crossbeams 212 extending between sidewalls 214. The crossbeams 212 are secured to the tray 210 with a plurality of the welds 20. With continued reference to FIG. 2 and additional reference to FIG. 3, the welds 20 may be used to weld brackets 220 to the crossbeams 212 and the sidewalls 214 to secure the crossbeams 212 in place.

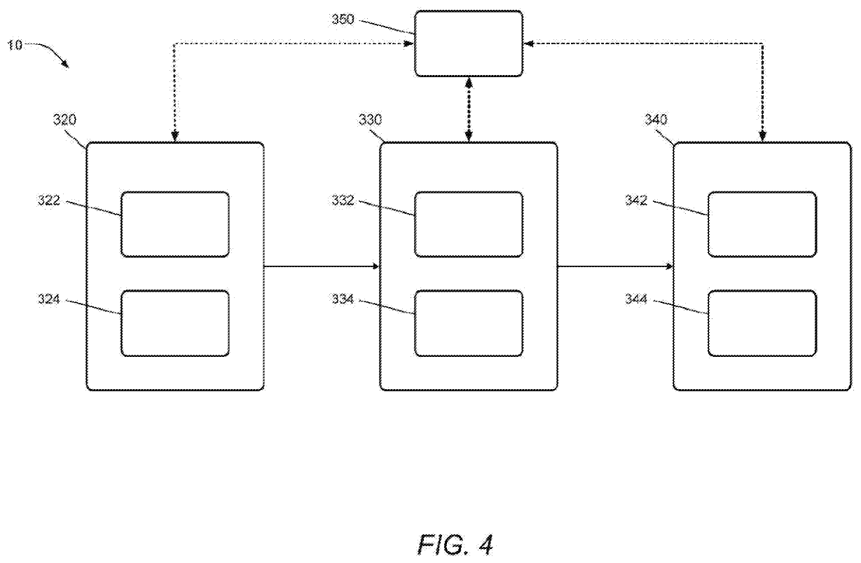

FIG. 4 illustrates additional features of the system 10 for inspecting and revising welds. The system 10 generally includes a weld inspection system 320, a weld revision system 330, and a weld revision verification system 340. A system controller 350 is in cooperation with each one of the weld inspection system 320, the weld revision system 330, and the weld revision verification system 340 to coordinate operation of the systems 320, 330, and 340. The tray 210 or other part including the welds 20 to be inspected is moved between different stations including the systems 320, 330, and 340, or components of the systems 320, 330, and 340 are moved to the part.

The weld inspection system 320 includes weld inspection sensors 322 (FIGS. 2 and 4) and an inspection controller 324. The weld inspection sensors 322 may be any suitable sensors configured to inspect the integrity of a plurality of the welds 20. For example, the weld inspection sensors 322 may include any suitable three-dimensional camera system configured to assess one or more parameters of the welds 20, such as, but not limited to, weld surface concavity, weld length, weld continuity (i.e., the extent to which the first and second welded areas 22, 24 are joined together), weld density, etc.

The inspection controller 324 is in cooperation with the weld inspection sensors 322 to receive the measured parameters captured by the sensors 322. The inspection controller 324 includes, or has access to, a schedule of predetermined weld parameters, each of which is associated with a weld rating representing quality of the weld, such as whether a weld exhibiting the particular parameters is acceptable or imperfect, for example. If imperfect, the schedule may include a more specific rating representing the degree of imperfection. The weld ratings may include, for example, an effectiveness rating, and/or a percent imperfect (or percent acceptable) rating, for example. The inspection controller 324 is configured to transfer the weld ratings to the system controller 350 along with a weld ID and location of the welds 20.

The system controller 350 is configured to designate one of more of the imperfect welds 20 for revision by the weld revision system 330. The system controller 350 is configured to group the welds 20, inspect the welds 20 of each group to identify imperfect welds 20, and make the revision designation based on the quantity of imperfect welds 20 within the same weld group. For example, if a total number of imperfect welds 20 within a particular weld group including the first imperfect weld 20 is equal to, or less than, an acceptable number of imperfect welds for the group, then the system 350 is configured to not select the first imperfect weld 20 for revision. Thus, not all imperfect welds 20 are designated for revision by the system controller 350. Alternatively, if a second one of the imperfect welds 20 within the designated group results in the quantity of imperfect welds 20 in the group to exceed the predetermined number of acceptable imperfect welds 20, then the system controller 350 is configured to select the second imperfect weld 20 for revision. The system controller 350 may also be configured to base the revision decision on the quantity of imperfect welds 20 on the tray 210 or other part.

The system controller 350 is also configured to identify a particular type of revision weld to be performed on each one of the welds 20 designated for revision. The revision weld will vary based on the particular imperfection of each one of the welds 20 designated for revision. Exemplary imperfections include the following: “false friend” imperfection where the first welded area 22 and the second welded area 24 do not meet, and thus a gap is defined therebetween; “burn through” imperfection where a hole is defined by one or both of the first welded area 22 and the second welded area 24; and “partial weld” imperfection where at least one of the first welded area 22 and the second welded area 24 are incomplete, such as due to a discontinued energy input (i.e., discontinued welding) at some areas, for example.

Based on the type of imperfection, the system controller 350 is configured to identify a revision weld that will correct the imperfection. For example, to correct the “false friend” imperfection, the system controller instructs a welding robot controller 334 to operate the welding robot 332 of the weld revision system 330 to perform a revision weld to join the first welded area 22 and the second welded area 24. To correct the “burn through” imperfection, the system controller 350 is configured to instruct the welding robot controller 334 to operate the welding robot 332 to perform a revision weld that will fill the burn through hole. To correct the “partial weld” imperfection, the system controller 350 is configured to instruct the welding robot controller 334 to operate the welding robot 332 to perform a revision weld that will complete the weld, such as rework the discontinued welding portion. The welding robot 332 may be any suitable welding robot, such as a robot including the robotic arm 120 and the welding element 110. The welding element may be configured to apply a metal inert gas weld, or any other suitable weld.

After the revision welds are complete, the system controller 350 is configured to instruct the weld revision verification system 340 to scan the verification welds to determine whether or not the revision welds have been performed. The weld revision verification system 340 includes any suitable weld verification sensors 342 (FIGS. 2 and 4) and a verification controller 344. The weld verification sensors 342 may be any suitable sensors configured to identify whether the verification weld has been performed. The weld verification sensors 342 may include one or more two-dimensional cameras, for example. The weld verification sensors 342 need not be configured to assess specific parameters of the verification weld (such as length, surface concavity, effectiveness, etc.). Instead, the weld verification sensors 342 need only be sufficient enough to identify that a verification weld was performed at a particular weld 30 designated for revision. As a result, the verification process is expedited.

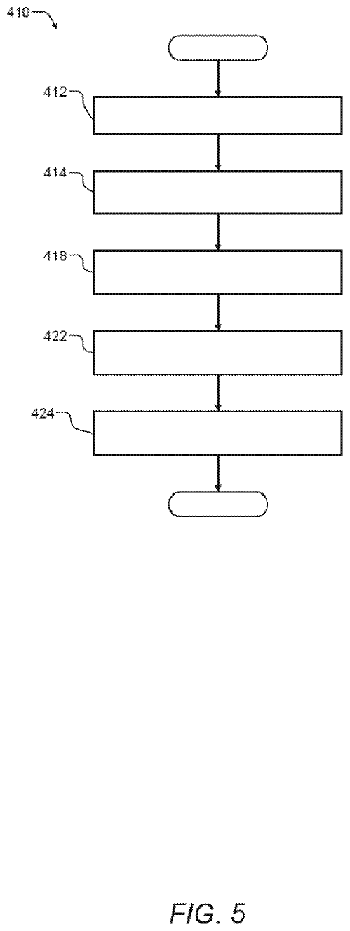

FIG. 5 illustrates an exemplary method 410 in accordance with the present disclosure for inspecting and revising any suitable welds, such as the welds 20. The method 410 may be performed using the system 10, or any other suitable weld inspection and revision system. The method 410 is described herein as being performed by the system 10 for exemplary purposes only.

At block 412, the system controller 350 instructs the inspection controller 324 to operate the weld inspection sensors 322 to inspect the welds 20. Based on weld parameter data gathered by the weld inspection sensors, and a comparison of the parameters to the schedule of parameters associated with both acceptable and imperfect welds, the inspection controller 324 is configured to determine whether the weld 20 is acceptable or imperfect. At block 414, the inspection controller 324 identifies the imperfect welds 20, and may assign a rating to the imperfect welds 20. For example, the rating may include a percent acceptable rating or a percent effective rating. The inspection controller 324 transmits to the system controller 350 a weld ID for each weld 20 determined to be imperfect identifying the location of each of the imperfect welds 20. The inspection controller 324 may also transmit the rating assigned to each one of the imperfect welds 20.

At block 418, the system controller 350 compares the positions of the imperfect welds to the acceptable welds, and determines whether to designate one or more of the imperfect welds for revision. The system controller 350 makes the designation decision based on the quantity of the imperfect welds relative to the acceptable quantity of imperfect welds for a designated weld group, as described above. Thus, if multiple imperfect welds 20 of the weld group result in the number of imperfect welds present to exceed the predetermined acceptable number of imperfect welds for the group, the system controller 350 is configured to designate one or more of the imperfect welds for revision. If the weld 20 determined to be imperfect does not cause the quantity of imperfect welds within the same group to exceed the predetermined acceptable number of imperfect welds for the group, then the imperfect weld will not be designated for revision.

At block 422, the system controller 350 transmits revision instructions to the welding robot controller 334 for revising the imperfect welds designated for revision. The revision instructions include the weld ID and location of each designated weld, as well as specific instructions for performing the revision weld. The revision weld instructions may include instructions for revising various imperfections, such as “false friend,” “burn through,” and/or “partial weld” imperfections as described above.

Upon receipt of the revision instructions, the welding robot controller 334 is configured to operate the welding robot 332 to perform the revision welds. The welding robot 332 is configured to move to each weld 20 and revise the welds 20 designated for revision. The revision weld may be a metal inert gas weld, or any other suitable weld.

After the revision welds are complete, the system controller 350 is configured to inspect the revision welds with the weld revision verification system 340 at block 424. The system controller 350 transmits the locations of the revision welds to the verification controller 344. The weld verification sensors 342, which may be any suitable two-dimensional cameras as described above, scan the welds 20 designated for revision to determine whether or not a revision weld has been made. The weld verification sensors 342 need only be configured to identify whether a revision weld has been performed. The weld verification sensors 342 do not have to be configured to identify specific characteristics of the revision welds, thereby speeding up the verification process. The results of the verification are transmitted from the verification controller 344 to the system controller 350. If one or more of the revision welds was not performed, the system controller 350 is configured to generate an alert, such as to alert an user that manual inspection and further revision may be required.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A system for inspecting and revising welds, the system comprising:
a weld inspection sensor configured to inspect weld parameters of the welds;
an inspection controller configured to identify a group of the welds, and identify one or more of the welds of the group as an imperfect weld based on the weld parameters;
a system controller configured to designate the imperfect weld for revision based on the weld parameters of the welds of the group and quantity of the welds of the group identified as imperfect by the inspection controller;
a welding robot controller configured to operate a welding robot to perform a revision weld at the imperfect weld; and
a weld verification sensor configured to identify a revision location of the revision weld,
wherein the system controller is configured to verify the revision weld based on the revision location identified by the weld verification sensor.

2. The system of claim 1, wherein the welds are on a battery support tray or floorpan of an electric vehicle.

3. The system of claim 1, wherein the weld inspection sensor includes at least one three-dimensional camera.

4. The system of claim 1, wherein the weld verification sensor includes at least one two-dimensional camera.

5. The system of claim 1, wherein the weld parameters include weld location and at least one of weld surface concavity and weld length.

6. The system of claim 1, wherein the system controller is configured to designate the imperfect weld for revision when the quantity of the welds of the group identified as imperfect exceeds a predetermined limit.

7. The system of claim 1, wherein the system controller is configured to designate the imperfect weld as acceptable when the quantity of the welds of the group identified as imperfect is below a predetermined limit.

8. The system of claim 1, wherein the system controller is configured to, based on the weld parameters of the imperfect weld, formulate revision weld instructions for the revision weld and transmit the revision weld instructions to the welding robot controller, and
wherein the welding robot controller is configured to operate the welding robot to perform the revision weld at the imperfect weld based on the revision weld instructions.

9. The system of claim 1, wherein the revision weld includes at least one of a metal inert gas weld and a laser weld.

10. The system of claim 1, further comprising a verification controller configured to receive the revision location of the revision weld, operate the weld verification sensor to check the revision location for the revision weld, and notify the system controller of presence of, or absence of, the revision weld at the revision location.

11. The system of claim 1, wherein the inspection controller is configured to identify one or more of the welds as imperfect by comparing the weld parameters to predetermined parameters.

12. A system for inspecting and revising welds, the system comprising:
a weld inspection sensor configured to inspect weld parameters of the welds including at least one of weld surface concavity, weld length, and weld continuity;
an inspection controller configured to identify a group of the welds, and identify one or more of the welds of the group as an imperfect weld based on the weld parameters;
a system controller configured to designate the imperfect weld for revision based on the weld parameters of the welds of the group and quantity of the welds of the group identified as imperfect by the inspection controller,
wherein based on the weld parameters of the imperfect weld, the system controller is further configured to formulate revision weld instructions for a revision weld;
a welding robot controller configured to receive the revision weld instructions from the system controller and operate a welding robot to perform the revision weld at the imperfect weld designated for revision based on the revision weld instructions; and
a verification controller configured to operate a weld verification sensor configured to perform a verification to determine whether or not the revision weld is present at the imperfect weld designated for revision, and transmit results of the verification to the system controller,
wherein the system controller is configured to verify the revision weld based on the results of the verification received from the system controller.

13. The system of claim 12, wherein the weld inspection sensor includes at least one three-dimensional camera.

14. The system of claim 13, wherein the weld verification sensor includes at least one two-dimensional camera.

15. The system of claim 12, wherein:
the system controller is configured to designate the imperfect weld for revision when the quantity of the welds of the group identified as imperfect exceeds a predetermined limit, and
the system controller is configured to designate the imperfect weld as acceptable when the quantity of the welds of the group identified as imperfect is at or below the predetermined limit.

16. A method for inspecting and revising welds comprising:
inspecting weld parameters of the welds with a weld inspection sensor;
identifying with an inspection controller a group of the welds, and one or more of the welds of the group as an imperfect weld based on the weld parameters;
designating with a system controller the imperfect weld for revision based on the weld parameters of the welds of the group and quantity of the welds of the group identified as imperfect by the inspection controller;
operating a welding robot with a welding robot controller to perform a revision weld at the imperfect weld designated for revision;
identifying a revision location of the revision weld with a weld verification sensor; and
verifying the revision weld with the system controller based on the revision location identified by the weld verification sensor.

17. The method of claim 16, further comprising identifying the revision location with multiple two-dimensional cameras.

18. The method of claim 16, further comprising designating with the system controller the imperfect weld for revision when the quantity of the welds of the group identified as imperfect exceeds a predetermined limit.

19. The method of claim 16, further comprising designating the imperfect weld as acceptable with the quantity of the welds of the group identified as imperfect is below a predetermined limit.

20. The method of claim 16, further comprising formulating revision weld instructions for the revision weld with the system controller based on the weld parameters of the imperfect weld designated for revision, and transmitting the revision weld instructions to the welding robot controller.
